(19) United States
(12) Patent Application Publication
(10) Pub. No.: US 2008/0059379 A1
(43) Pub. Date: Mar. 6, 2008

(54) Method and apparatus for biometrically secured encrypted data storage and retrieval

(75) Inventors: Jonathan E. Ramaci, Charleston, SC (US); Lee Weinstein, Arlington, MA (US); Kenneth H. Sinclair, Waban, MA (US)

Correspondence Address: WILMERHALE/BOSTON, 60 STATE STREET, BOSTON, MA, 02109, US

(73) Assignee: iCache, Inc., Cambridge, MA (US)

(21) Appl. No.: 11/804,430

(22) Filed: May 18, 2007

Related U.S. Application Data
(60) Provisional application No. 60/801,359, filed on May 18, 2006.
(60) Provisional application No. 60/903,644, filed on Feb. 26, 2007.

(51) Int. Cl. G06Q 99/00

(52) U.S. Cl. 705/66; 705/41; 705/65; 705/67

(57) ABSTRACT

An electronic wallet which is biometrically secured stores credit card and other information. A biometric sensor prevents the electronic wallet from being used by the user who does not have permission to use the wallet. A rewriteable card is inserted into a slot of the wallet in order to have credit card information placed on the card. After the card is used the information is erased from the card when it is placed back in the slot in the electronic wallet.

### CROSS-REFERENCE TO RELATED PATENT APPLICATIONS

This patent application claims priority to U.S. Provisional Patent Application Ser. No. 60/903,644 filed Feb. 26, 2007 and U.S. Provisional Patent Application Ser. No. 60/801,359 filed May 18, 2006 the teachings of which are incorporated herein by reference.

### FIELD OF THE INVENTION

The field of the invention relates to electronic wallets and more specifically to a biometrically secured electronic wallet with a detachable reconfigurable card.

### BACKGROUND OF THE INVENTION

Throughout history, methods of paying for goods and services have evolved from barter systems, to cash currency systems, to electronically-enabled currency systems such as credit cards and smart cards. With each of these systems theft has been an issue. While each new payment method developed over the years includes improved theft deterrent mechanisms, the risk of theft is still very real. As a result, there is need for payment systems which have even higher barriers to fraudulent use. U.S. Pat. No. 7,003,495, issued to Burger et al. discloses an electronic wallet product which is capable of reading the magnetic strips of a multitude of credit cards and then emulating any credit card it has stored, through a “detachable token”. The token may have the form factor of a credit card and may include a “virtual magnetic stripe”, which may be programmed to behave as one of a multitude of credit cards. There is a need for continued innovation which will enable consumers to keep their information and money secure, while enabling authorized individuals to easily conduct financial transactions involving such information.

It is an object of the present invention to provide a secure portable digital device that provides a convenient replacement for modern credit cards and smart cards, while simultaneously providing higher barriers to fraudulent use.

It is a further object of the present invention to provide a device to enable to carry around a variety of private information in an encrypted form, such that the consumer may easily access the data by providing biometric proof of identity.

It is a further object of the present invention to provide consumers the ability to conduct peer-to-peer financial transactions in new ways.

It is a further object of the present invention to provide parents with a new means and method for remotely enabling a financial transaction for children.

It is a further object of the present invention to facilitate high-security electronic fund transfer at lower cost, with less geographic restriction and less restriction on time-of transfer of funds.

### SUMMARY OF THE INVENTION

In one aspect, the present invention provides consumers with a portable electronic device not much larger than a credit card, which acts as a biometrically enabled electronic wallet that is capable of completely emulating a variety of credit cards and/or smart cards a consumer might normally carry, while providing significantly less risk of fraudulent use of such device if stolen or lost. In a preferred embodiment, once consumer biometric identification data (such as fingerprint data) is entered into the electronic wallet (for instance, by swiping a finger print over a fingerprint sensor on the electronic wallet), the consumer may then enter credit card data for a number of credit cards into the electronic wallet (for instance, through a personal computer attached to the electronic wallet, or by inserting and removing existing credit cards such that the electronic wallet reads the magnetic strip on such cards).

In another aspect, the present invention serves as a secure repository for personal information or data which a consumer may wish to carry. Such data may include data such as medical records and/or insurance data for use in emergencies, travel documents, forms of identification, photographs, text documents, graphical documents, digital audio and/or video recordings, and the like.

In a preferred embodiment, the electronic wallet of the present invention contains within it a secure processor which is highly resistant to tampering, and this processor serves as a means for securely encrypting any data which is to be stored in the electronic wallet, including the biometric data which is used to determine whether someone attempting to use the wallet is authorized to use the wallet. Internal solid-state memory is provided within the electronic wallet to enable consumers to store a variety of documents, digital audio, digital video, etc in encrypted form, so that such information can be accessed by a user who is successfully biometrically identified (for instance, through a valid fingerprint).

In a preferred embodiment, the electronic wallet of the present invention also contains a removable card, capable of emulating a credit card and/or smart card. The electronic wallet has a graphical display on which an authorized consumer may select which of a number of credit cards the removable card is to be configured to emulate upon removal. In an embodiment where the removable card emulates a credit card, the electronic wallet writes magnetic data to the magnetic strip of the removable card as the card is removed from the electronic wallet. In a preferred embodiment, although the user may choose to have the removable card emulate any of a number of credit cards in a given instance, one credit card is programmed as the “default choice” for a particular electronic wallet. Thus an institution (such as a credit card issuer) may be rewarded for paying for part or all of the cost of a given consumer's electronic wallet, having the credit card of that institution designated as the “default card” of that electronic wallet.

The electronic wallet of the present invention can receive data through multiple means, such as an internal magnetic stripe reader, an internal smart-card reader, an internal wireless RFID interface, an internal wireless pager interface, an internal wireless LAN interface, an internal GPS receiver, an internal cellular data transceiver, a USB port, an iPod connector port, an infrared data port (such as may be used on PDAs, laptop computers, and the like), or any other wired or wireless data interface as may become a standard of the day.

The present invention also provides convenient means for consumer to back up encrypted data in a highly secure fashion external to the electronic wallet of the present invention. In a preferred embodiment, the security of externally-backed-up data is enhanced by splitting the backed up data into multiple databases such that if any given database is compromised only a fraction of a given consumer's data can become potentially known.

These and other objects and features of the present invention will be more fully understood from the following detailed description which should be read in light of the accompanying drawings in which corresponding reference numerals refer to corresponding parts throughout the several views.

### BRIEF DESCRIPTION OF THE DRAWINGS

FIG. 1 is a block diagram of a preferred embodiment of an electronic wallet according to the present invention.

FIG. 2A is a front view of the electronic wallet of the present invention.

FIG. 2B is a left side view of the electronic wallet shown in FIG. 2A.

FIG. 2C is a right side view of the electronic wallet shown in FIG. 2A.

FIG. 2D is a top view of the electronic wallet shown in FIG. 2A.

FIG. 2E is a bottom view of the electronic wallet shown in FIG. 2A.

FIG. 3A is a flow chart of the process of initializing an electronic wallet according to the present invention.

FIG. 3B is a flow chart of the process of replacing a lost or stolen electronic wallet according to the present invention.

### DETAILED DESCRIPTIONS OF THE PREFERRED EMBODIMENTS

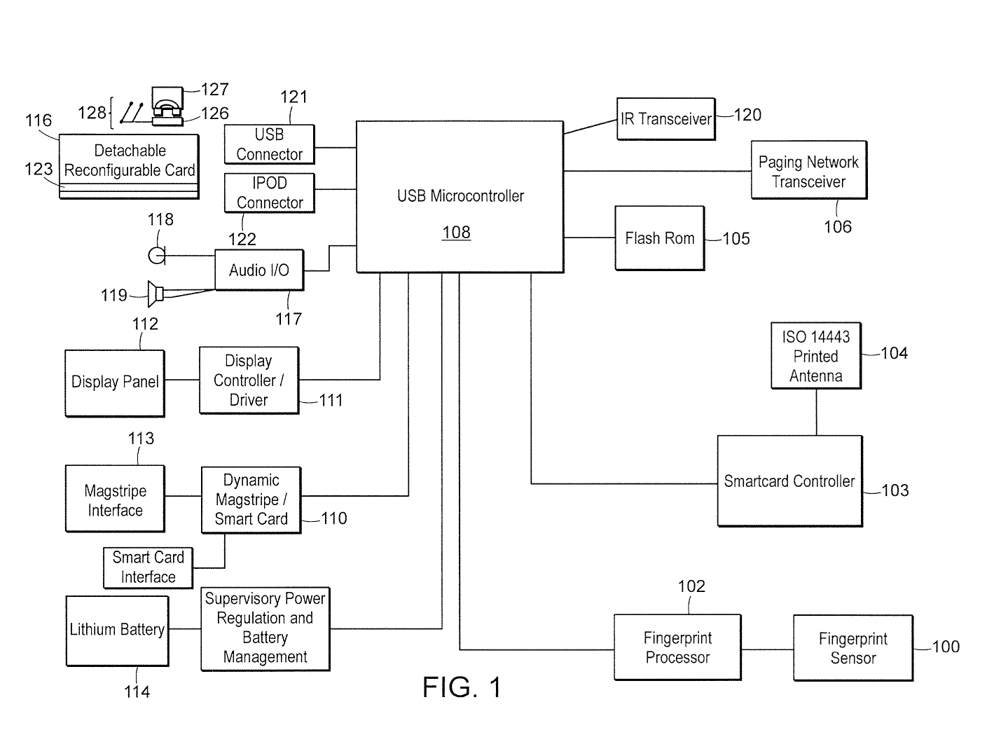

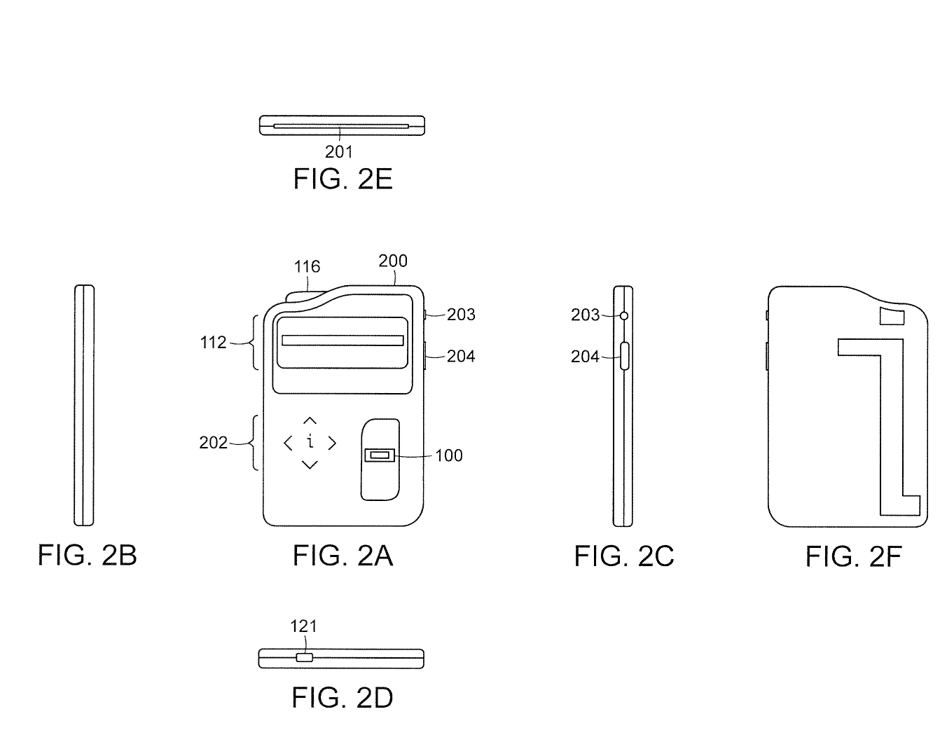

Referring to FIGS. 1 and 2A-2E, the electronic wallet 200 of the present invention is shown. This electronic wallet is of a size just slightly larger than a credit card. The wallet 200 stores both credit card information and personal information of the owner of the electronic wallet 200. The electronic wallet 200 will be biometrically secured. In the embodiment shown in FIGS. 1 and 2A-2E, this biometric security is provided through a fingerprint sensor 100. Fingerprint sensor 100 may be a Upek TCS3CF sensor or the like, which is capable of acting as a low-standby-power wake-up device, a fingerprint reading device, a navigation device (providing movement sensing like a computer mouse), and a tap-sensing device (providing click detection like a computer mouse). In a preferred embodiment, when the user places a finger on fingerprint sensor 100, the wake-up sensing feature of fingerprint sensor 100 wakes up at least fingerprint data processor 102.

A magnetic-stripe interface 113 contains active magnetic-stripe-writing means controlled by magnetic strip read/write control electronics 110 (for transferring identification data of a selected credit card to the magnetic strip of removable card 116 prior to card use), and passive magnetic-strip-erasing means (including permanent magnet 127) for erasing the data from the magnetic strip as the removable card is re-inserted in the electronic wallet 200 after the consumer uses the removable card 116 for a financial transaction. The passive magnetic-strip-erasing means are preferably effective even if the battery of the electronic wallet is dead or the electronics of the electronic wallet are non-functional for some reason at the time the removable card 116 is re-inserted in the slot 201 of the electronic wallet 200, thus reducing the chance that the removable card 116 could be stolen and fraudulently used.

In an alternate embodiment, the removable card 116 of the present invention contains a power source, and an actively driven smart card emulator and/or magnetic strip emulator. In such an embodiment, the actively driven magnetic strip or smart card emulator is only driven for a brief period of time (for example 10 seconds, or a minute), significantly reducing the chance that the removable card could be used fraudulently.

Display panel 112 briefly displays any validation number associated with a given credit card being emulated by the removable card. This further reduces the chance of fraudulent use of the removable card. Display controller/driver electronics 111 is fed decrypted data and translates such data into graphical images of text, barcodes, photographs, and the like.

USB microcontroller 108 acts as a data pipe and peripheral interface and controller. USB controller 108 may pass encrypted data or unencrypted data, but it does not perform encryption of decryption functions. Instead encryption and decryption functions are provided by smart card controller 103 and fingerprint processor 102. Thus when a user presents a fingerprint, the unencrypted fingerprint data only briefly exists (within fingerprint sensor 100 and on data lines to fingerprint processor 102). Fingerprint processor 102 encrypts the fingerprint data and stores fingerprint data internally in encrypted form, or may pass encrypted fingerprint data to USB processor 108 to store in flash ROM 105.

Consumers may elect to have data to be stored within the electronic wallet encrypted or not encrypted. Data that is not to be encrypted might for instance include instructions who to call or where to mail the electronic wallet if it is found after being lost. Data to be secured is encrypted by smart card controller 103 prior to being stored in flash ROM 105, and is decrypted by smart card controller 103 prior to being read out through wireless RFID interface 104, wireless transceiver 106 (which may be a paging transceiver, a LAN transceiver, or the like), IR transceiver 120, audio transceiver 117, display 112, or magnetic card and smart card interface 110.

In a preferred embodiment, a rechargeable lithium battery 114 provides power for at least a week of typical use, and is recharged through USB connector 112 when the electronic wallet is occasionally connected to a personal computer, USB charging station or the like. Battery management and power regulation circuitry 109 control charging of lithium battery 114 and also control power supplied to various electronic subsystems of the electronic wallet 200, such as the magnetic strip read/write circuitry 110, smart card controller 103, wireless RFID interface 104, wireless transceiver 106, IR transceiver 120, audio interface 117, display controller/driver 111, and display 112.

Fingerprint processor 102 and smart card controller 103 are able to exchange encrypted messages either through public key encryption or symmetric encryption, and symmetric encryption keys are exchanged using public key encryption. Smart card controller 103 preferably runs the MULTOS secure operating system with a custom shell, and supervises all communication of secure data in and out of the electronic wallet 200 of the present invention.

Voice notes may be taken using the electronic wallet by waking up the wallet and validating a user through processing a fingerprint on fingerprint sensor 100, then using fingerprint sensor 100 as a navigation device to select audio recording from a menu on display 112, and speaking into microphone 118. Such audio recordings may similarly be listened to through speaker 119 by selecting the audio recording desired using navigation sensor 100 to select an appropriate menu item on display 112. Audio electronics module 117 contains analog-to-digital (A/D) and digital-to-analog (DAC) circuitry, as well as microphone preamplifier and speaker amplifier circuitry.

Graphical display module 112 is at least 176 pixels by 132 pixels, and is capable of reproducing standard barcodes as might be used for presenting coupons, tickets, etc. electronically. This display is either an OLED or LCD display. Magnetic strip interface 113 incorporates a permanent magnet 127 of sufficient strength to erase magnetic strip 123 of removable reconfigurable card 116 when card 116 is reinserted into electronic wallet 200. Reconfigurable card 116 slides into electronic wallet 200 through slot 201. One corner of electronic wallet 200 is sculpted so that one corner of reconfigurable card 116 is slightly exposed when reconfigurable card 116 is inserted all the way into electronic wallet 200. Eject button 204 is provided to aid in ejection of card 116. Eject button 204 moves card 116 partially out of electronic wallet 200, making the exposed corner of card 116 easier to grasp.

A position feedback sensor in magnetic strip interface 113 dynamically provides information on the position of card 116 within electronic wallet 200 as the card 116 is withdrawn, enabling the proper spatial writing of magnetic data onto magnetic strip 123. In various embodiments, dynamic position sensing of card 116 may be accomplished through a contact wheel, through an optical information track, through a magnetic track separate from standard magnetic data tracks on magnetic strip 123, through a mechanical strip which is acoustically sensed, or by other methods of position sensing as may commonly be known in the art. Electronically readable position indicating strip 124 is incorporated into card 116 to facilitate dynamic position sensing, and to differentiate reconfigurable card 116 from standard credit cards, so that erasure of standard credit cards is not automatically performed if such cards are inserted into and removed from electronic wallet 200. Alternatively, engagement of the automatic erasure function may also be caused by the presence of a mechanical feature of card 116 such as notch 125 that mechanically engages a magnetic-shield-moving mechanism 128 within electronic wallet 200, such that magnetic shield 126 (which normally shunts magnetic field from erasure permanent magnet 127 so that credit cards may be read into electronic wallet 200 without having their magnetic strips erased) is mechanically moved to a non-shielding position when reconfigurable card 116 is inserted into electronic wallet 200, thus facilitating the erasure of reconfigurable card 116 upon reinsertion, regardless of the availability of power from lithium battery 114.

The touch of a finger on fingerprint sensor 100 “wakes up” the electronic wallet 200. In an alternate embodiment offering longer battery life, “wake up” is initiated through electro-mechanical power button 203. Fingerprint sensor 100 also serves as a navigation sensor when power is “on”, so that vertical movement of a finger on sensor 100 causes vertical movement of a cursor on display 112, horizontal movement of a finger on sensor 100 causes horizontal movement of a cursor on display 112, and tapping on fingerprint sensor 100 acts as a “mouse click” at the current position of a cursor on display 112. A navigation keypad 202 may be provided to navigate cursor position and provide a selection or clicking function.

In a preferred embodiment of the present invention incorporating wireless receiver 106 in electronic wallet 200, processes using encrypted consumer data (such as use of credit cards) may be remotely authorized. For example, if a parent gives a child an electronic wallet 200, the electronic wallet 200 may be configured to require not only the child's fingerprint to authorize use, but also a remotely delivered encrypted authorization message from a parent. In such a situation, a child wishing to make a purchase might call home on a cell phone, and the parent might authorize the purchase by signing in to a secure website and filling out a form which causes an encrypted message to be sent to the child's electronic wallet via a paging transmitter. Such processes may similarly be remotely authorized in embodiments where wireless receiver 106 is a wireless LAN transceiver such as might be used with a standard such as 802.11b, 802.11g or the like.

Consumer data (such as use of credit card data) may be delivered to an electronic wallet in encrypted form via a wireless connection. For example, if an employee of a corporation was in the field and wished to make a purchase using a company credit card, both the company credit card itself and the authorization to use such credit card may be temporarily transferred to that employee via a wireless network (such as a pager network or wireless LAN connected through wireless transceiver 106), or via a wired network (such as the internet, connected through USB connector 121).

The above-described temporary or permanent transfer of consumer data and/or transaction authorization data to an electronic wallet of the present invention via a wireless network or wired network may convey the ability to conduct a financial transaction of an unlimited amount, or such data transfer may convey the ability to conduct a potentially unlimited amount of financial transactions. The electronic wallet 200 may also be remotely provided with a limited-amount financial transaction capability. For example, a consumer might purchase on-line a gift card of a certain value at a certain store, and that gift card could be transferred to the consumer in electronic form. That gift card could then be loaded in electronic form into the consumer's own electronic wallet, or such gift card could be remotely transferred to the electronic wallet of a friend or relative. The type of gift cards which can be transferred in this manner include store-specific gift cards, pre-paid telephone cards, pre-paid gasoline cards, and the like. Thus, consumers may transfer financial authority and funds to each other without going through existing costly and/or potentially time consuming or time-restricted methods of electronic fund transfer.

Some portion of flash ROM 105 is configured to act as a mass storage peripheral to any PC to which an electronic wallet 200 is attached. Data written to ROM 105 is encrypted automatically by smart card controller 103 when written, and decrypted automatically by smart card controller 103 when read, and such encryption and decryption only take place after authorizing biometric data (such as a fingerprint) are presented. Businessmen and the like who may commonly work on confidential documents and with confidential data while traveling may store such confidential data in a biometrically secured electronic wallet, and such data will be unreadable to anyone who steals such an electronic wallet.

In a preferred embodiment, consumers may elect to back up consumer data (exclusive of credit card data in either encrypted or unencrypted form, to their own PC or to a secure internet-accessible database. Credit card and other similar data relating to cards and accounts provided by different financial service providers may be backed up only in encrypted form in separate databases via internet connection according to the present invention. This feature provides an extra level of security both for consumers and for financial service providers.

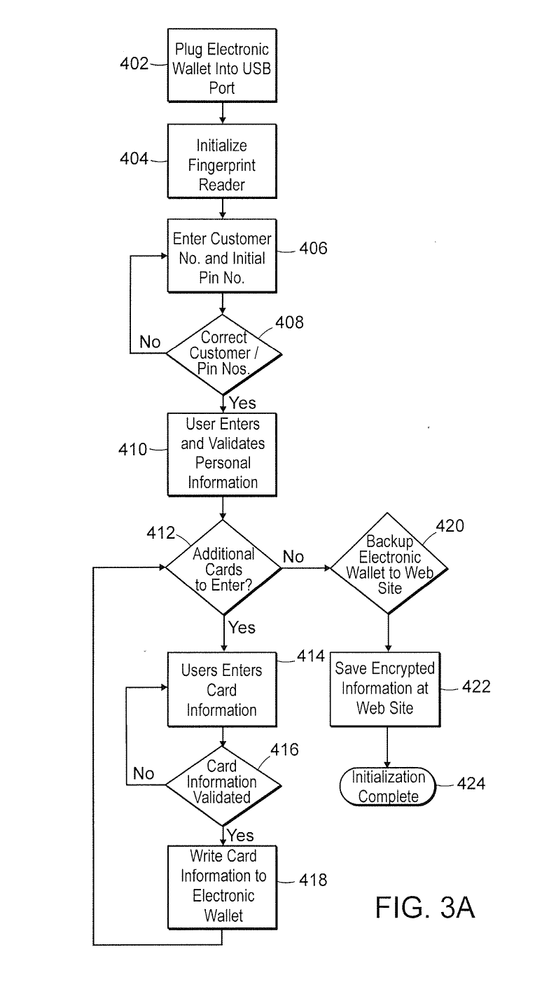

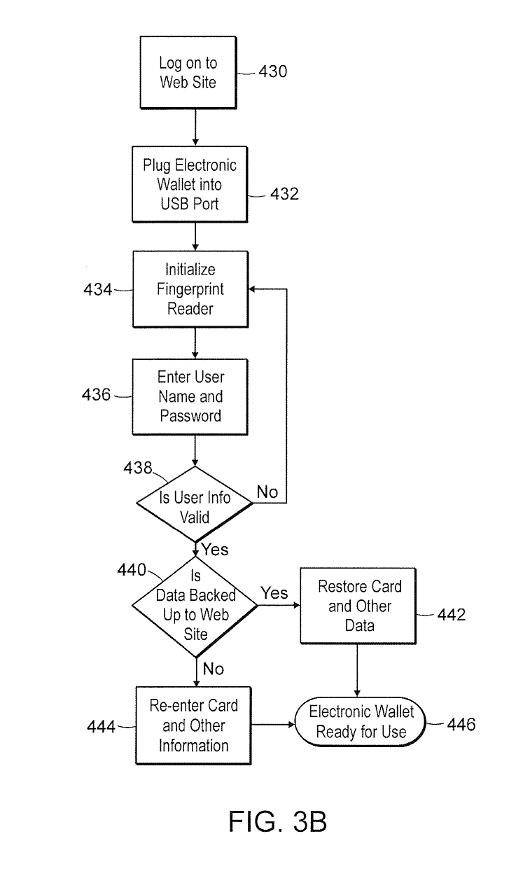

Turning now to FIG. 3A, the process for initializing a device will now be described. In step 402 the electronic wallet is plugged into a computer's USB port which automatically starts initializing software on the computer. In Step 404 the user initializes the fingerprint reader by running the user's fingerprint over the reader and at that point an encrypted data partition is created in the electronic wallet. The user is then asked in Step 406 to enter a customer number and an initial PIN number that has been provided separately to the user. If the customer number and/or PIN number are not correct as determined in Step 408 the user is requested to repeat Step 406. If the number is correct the user is asked to validate and correct personal information in Step 410 and the initial data is loaded into the electronic wallet. In Step 412 the user is asked whether any credit cards need to be entered into the electronic wallet and in Step 414 the user enters any additional information that is not obtained from the card into the electronic wallet 200 through the PC that is connected to the electronic wallet 200. In Step 416 the computer to which the wallet 200 is connected will validate the card information and if it is not correct the computer will request the user to repeat Step 414 and if the information is correct, the computer will ask the user whether or not additional cards are to be entered in Step 412. If the card information is validated in Step 416, the card information is read to the electronic wallet in Step 418. If no additional cards need to be entered, the customer elects in Step 420 whether to back up the electronic wallet to a website, and if the customer elects to so back up the information, encrypted information is stored at a website. At this point the initialization of the electronic wallet is concluded.

Referring now to FIG. 3B, the process for replacing a lost, stolen or broken electronic wallet will now be described. In Step 430 the user logs into a designated website that provides service to the users of electronic wallets. Once the user receives the new wallet 200 the user plugs the new electronic wallet 200 into a computer USB port in Step 432 which automatically triggers the startup of the initializing software. The user initializes the fingerprint reader in Step 434 and an encrypted data partition is created in the new electronic wallet 200. The user in Step 436 enters the user name and password and in Step 438 the user's fingerprint, user name and password are validated. In Step 440 the system determines whether or not the user's data is backed up on the applicable website and if it is backed up, credit card data and other information is restored to the new electronic wallet in Step 442. If the information is not stored at a website the user must re-enter such information in Step 444 and at that point the iCache is ready for use.

Within this document, “biometric” devices referred to are devices capable of verifying a person's identity through measurement (and comparison to previous measurement) of biometric characteristics such as fingerprints, voice characteristics, retina characteristics, etc. While the preferred embodiments have been described with respect to fingerprint sensors any other biometric sensor could be substituted.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. An electronic wallet comprising
a housing including a slot;
a display secured to said housing and visible on an exterior surface of said housing for displaying information stored in the electronic wallet;
a biometric sensor mounted on an exterior surface of said housing, said biometric sensor being used to verify the identity of a user of the electronic wallet;
a card including a rewritable memory for temporarily storing information, said card having dimensions such that said card can fit at least partially within said slot;
a controller positioned within said housing for verifying the identity of the user through information obtained by said biometric sensor and for causing information to be written to said rewritable memory on said card.

2. The electronic wallet of claim 1 comprising a flash memory positioned within said housing for storing information.

3. The electronic wallet of claim 1 wherein said rewritable memory on said card is a magnetic strip and wherein said electronic wallet further comprises a magnetic strip reader for acquiring information from magnetic strips on cards inserted into said slot.

4. The electronic wallet of claim 1 further comprising a smart card controller that encrypts data read from magnetic strips of said cards inserted into said slot.

5. The electronic wallet of claim 1 further comprising a magnet for erasing said rewritable memory on said card when said card is inserted into said slot.

6. The electronic wallet of claim 1 wherein said biometric sensor is a fingerprint sensor.

7. The electronic wallet of claim 1 wherein said controller backs up data stored on said electronic wallet by dividing said data to be backed up into several components and storing at least two of said components in different databases.

8. The electronic wallet of claim 1 further comprising an audio input/output circuit for receiving audio signals from a user and for generating sound signals from said electronic wallet.

9. The electronic wallet of claim 5 wherein said magnet will erase said rewritable memory even if said electronic wallet is not powered on.

10. A method of using a secure electronic device, comprising:
storing credit card magnetic strip information as encrypted data within a portable electronic device;
biometrically enabling decryption of said encrypted data by presenting biometric data to a biometric sensor incorporated in said portable electronic device;
decrypting said credit card magnetic strip data;
writing said credit card magnetic strip data to a magnetic strip on a magnetically reconfigurable card through a card writing interface incorporated in said electronic device; and
removing said magnetically reconfigurable card from contact with said electronic device.

11. The method of using a secure electronic device of claim 10 further comprising the step of.
returning said magnetically reconfigurable card into mechanical contact with said portable electronic device in such a way as to automatically erase said magnetically reconfigurable card sufficiently so that said card is no longer readable by typical consumer-transaction magnetic card readers.

12. The method of using an a secure electronic device of claim 11 wherein said automatic erasing is accomplished by passing the magnetic strip of said reconfigurable card through a magnetic field produced by a permanent magnet.

13. The method of using an a secure electronic device of claim 11, wherein said step of returning said reconfigurable card to contact with said electronic device comprises slidably inserting said reconfigurable card into said electronic device, and wherein said automatic erasing is enabled through detection of a mechanical feature of said reconfigurable card.
